(19) United States
(12) Patent Application Publication
(10) Pub. No.: US 2010/0145785 A1
(43) Pub. Date: Jun. 10, 2010

(54) SYSTEM AND METHOD FOR CALCULATING MILEAGE POINTS

(75) Inventors: Dong-Gil NA, Daejeon (KR); Jaemin SEOL, Seoul (KR); Hyeonguk KIM, Seongnam-si (KR); Hoon JUNG, Daejeon (KR); Jong Heung PARK, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/630,439

(22) Filed: Dec. 3, 2009

(30) Foreign Application Priority Data
Dec. 4, 2008 (KR) 10-2008-0122732
Jul. 2, 2009 (KR) 10-2009-0060367

(51) Int. Cl. G07B 17/02; G06Q 10/00; G06Q 30/00; G06Q 50/00

(52) U.S. Cl. 705/14.27; 705/402

(57) ABSTRACT

A mileage point calculating system receives mail acceptance data including respective acceptance information of a plurality of mail groups and acceptance information of a combined mail group generated by combining the plurality of mail groups, determines a first combined fee generated by summing postage of the plurality of mail groups according to acceptance information of the plurality of mail groups, determines a second combined fee corresponding to postage of the combined mail group according to acceptance information of the combined mail group, and calculates a margin between the first combined fee and the second combined fee as mileage points

### CROSS-REFERENCE TO RELATED APPLICATION

This application claims priority to and the benefit of Korean Patent Applications No. 10-2008-0122732 filed in the Korean Intellectual Property Office on Dec. 4, 2008 and No. 10-2009-0060367 filed in the Korean Intellectual Property Office on Jul. 2, 2009, the entire contents of which are incorporated herein by reference.

### BACKGROUND OF THE INVENTION

(a) Field of the Invention

The present invention relates to a system and method for calculating mileage points. Particularly, the present invention relates to a system and method for calculating mileage points according to previous sorting and acceptance regarding a large quantity of mail.

(b) Description of the Related Art

A sender or a dispatch service provider of a large amount of mail produces a large amount of mail and has the same accepted by a postal service provider by entrusting it to a mail dispatch agency. In this instance, the postal service provider provides a fee reduction to the client who sends a great quantity of mail or sorted mail. Particularly, the postal service provider additionally reduces the fee when the client sorts the mail by 3 or 5 digits of the postal codes, an automated area distribution center (AADC), or a mixed automated area distribution center (mixed AADC).

In this instance, when the agency gathers the mail entrusted by a plurality of clients, sorts them, and has them accepted according to mail categories, the task to be processed by the postal service provider is decreased.

However, the postal service provider provides the fee reduction service to a sender or a dispatch service provider of a large amount mail other than the agency who is entrusted to produce mail and have the same accepted by the clients. Therefore, when the agency processing many clients' mail collects and sorts the respective clients' mail and brings the same to the postal service provider, it is difficult to return the benefits caused by the sorting task to the agency.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for providing benefits to an agency producing a large amount of mail and having it accepted.

An exemplary embodiment of the present invention provides a method for providing mileage points based on received data including: the system receiving mail acceptance data including respective acceptance information of a plurality of mail groups and acceptance information of a combined mail group generated by combining the plurality of mail groups; the system determining a first combined fee generated by summing postage of the plurality of mail groups according to acceptance information of the plurality of mail groups; the system determining a second combined fee corresponding to postage of the combined mail group according to acceptance information of the combined mail group; and the system calculating a margin between the first combined fee and the second combined fee as mileage points.

An exemplary embodiment of the present invention provides a system for calculating mileage points including: an information storage unit for storing a postage table; a fee calculator for calculating postage of partial or entire mail pieces according to acceptance data of the mail pieces based on the postage table; and a mileage point calculator for calculating mileage points on the mail pieces based on postage of partial or entire mail pieces.

According to an embodiment of the present invention, mileage points are calculated for an agency producing and sending a large amount of mail according to sorting mail so that the agency may have the mail accepted after sorting a large amount of mail, thereby reducing the postal service provider's sorting task.

### BRIEF DESCRIPTION OF THE DRAWINGS

FIG. 1 shows a configuration of a mileage point calculating system according to an exemplary embodiment of the present invention.

FIG. 2 shows a mileage point calculating method according to an exemplary embodiment of the present invention.

FIG. 3 shows a first combined fee determining method according to an exemplary embodiment of the present invention.

FIG. 4 shows a second combined fee determining method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A mileage point calculating system and method according to an exemplary embodiment of the present invention will now be described with reference to accompanying drawings.

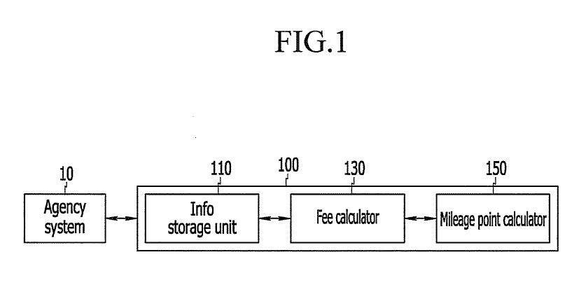

Referring to FIG. 1, a mileage point calculating system for a postal service provider according to an exemplary embodiment of the present invention to provide mileage points to an agency sending a large amount of mail according to a method of accepting a large amount of mail will now be described.

FIG. 1 shows a configuration of a mileage point calculating system according to an exemplary embodiment of the present invention.

As shown in FIG. 1, the mileage point calculating system 100 for receiving mail acceptance data from an agency system 10 and calculating mileage points based on the received data includes an information storage unit 110, a fee calculator 130, and a mileage point calculator 150. In this instance, the mail acceptance data include grade information, type information, weight information, and classification information of a plurality of mail pieces.

The information storage unit 110 stores information for calculating fees and mileage points. In this instance, the information storage unit 110 can store postage calculating information in advance. The postage calculating information can follow the postage table of Table 1.

TABLE 1

| | | | Classification | | | |
|---|---|---|---|---|---|---|
| | | | Automation | | | |
| | | | | | | Mixed |
| Grades | Types | Weights | 5-digit | 3-digit | AADC | AADC |
| First-class | Commercial | Below 1 | $0.335 | $0.357 | $0.360 | $0.382 |
| mail | letters | ounce | | | | |
| | | Below 2 | $0.460 | $0.482 | $0.485 | $0.507 |
| | | ounce | | | | |
| | | Below 3 | $0.585 | $0.607 | $0.610 | $0.632 |
| | | ounce | | | | |
| | | Below | $0.710 | $0.732 | $0.735 | $0.757 |
| | | 3.5 | | | | |
| | | ounce | | | | |

As expressed in Table 1, the postage depends on mail grade, type, weight,

The fee calculator 130 calculates postage of mail pieces based on postage calculation information.

The mileage point calculator 150 calculates mileage points according to mail combination and classification by an agency for the mail pieces based on postage for the plural mail pieces.

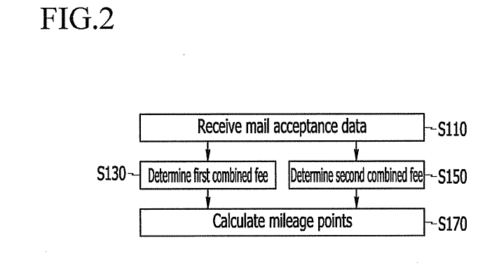

Referring to FIG. 2 to FIG. 4, a mileage point calculating method according to an exemplary embodiment of the present invention will be described.

FIG. 2 shows a mileage point calculating method according to an exemplary embodiment of the present invention.

As shown in FIG. 2, the mileage point calculating system 100 receives mail acceptance data from the agency system 10 (S110). In this instance, the mail acceptance data include acceptance information of a plurality of mail groups and acceptance information on the combined mail groups generated by combining a plurality of mail groups. Also, the acceptance information includes grade information, type information, weight information, and classification of mail.

The fee calculator 130 determines a first combined fee based on acceptance information of a plurality of mail groups (S130). In this instance, the plurality of mail groups corresponds to the first mail group and the second mail group.

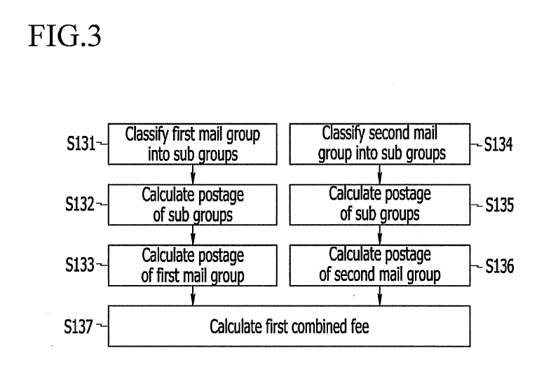

Referring to FIG. 3, a method for the fee calculator 130 to determine the first combined fee according to an exemplary embodiment of the present invention will now be described.

In this instance, according to acceptance information of the first mail group, the grade of mail pieces included in the first mail group is first-class mail, the type is commercial letter, and the weight is less than 1 ounce. In this instance, the mail included in the first mail group is configured with 10,000 mail pieces classified by 5-digit postal codes and 100,000 mail pieces classified by 3-digit postal codes.

Also, according to acceptance information of the second mail group, the grade of mail pieces included in the second mail group is first-class mail, the type is commercial letter, and the weight is less than 1 ounce. In this instance, the mail pieces included in the first mail group is configured with 10,000 mail pieces classified by a 5-digit postal code and 100,000 mail pieces classified by a 3-digit postal code.

FIG. 3 shows a first combined fee determining method according to an exemplary embodiment of the present invention.

As shown in FIG. 3, the fee calculator 130 classifies the first mail group into at least one sub group according to the acceptance information of the first mail group based on a stored postage table (S131). In this instance, respective sub groups include mail pieces to which the same postage is applied according to grade information, type information, weight information of, and classification information included in the first mail group. Also, when the postage table follows Table 1, the fee calculator 130 can classify the first mail group into a first sub group and a second sub group. In this instance, the first sub group of the first mail group includes 10,000 mail pieces classified by a 5-digit postal code and the second sub group includes 100,000 mail pieces classified by a 3-digit postal code.

The fee calculator 130 calculates postage of respective sub groups of the first mail group based on the postage table (S132). In this instance, when the postage table follows Table 1, the fee calculator 130 can calculate the postage of the first sub group of the first mail group as $3,350 (=$0.335*10,000 mail pieces) and the postage of the second sub group as $35,700 (=$0.357*100,000 mail pieces).

The fee calculator 130 calculates postage of the first mail group by summing the postage of the respective sub groups (S133). That is, the fee calculator 130 calculates postage of the first mail group as $39,050 by summing $3,350, the postage of the first sub group of the first mail group and $35,700, the postage of the second sub group.

The fee calculator 130 classifies the second mail group into at least one sub group according to acceptance information of the second mail group based on the postage table (S134). In this instance, respective sub groups include grade information, type information, weight information, and classification information of the mail pieces included in the second mail group. When the postage table follows Table 1, the fee calculator 130 can classify the second mail group as a first sub group and a second sub group. Here, the first sub group of the second mail group includes 10,000 mail pieces classified by a 5-digit postal code and the second sub group includes 100,000 mail pieces classified by a 3-digit postal code.

The fee calculator 130 calculates postage of respective sub groups of the second mail group based on the postage table (S135). In this instance, when the postage table follows Table 1, the fee calculator 130 can calculate the postage of the first sub group of the second mail group as $3,350 (=$0.335*10,000 mail pieces) and the postage of the second sub group as $35,700 (=$0.357*100,000 mail pieces).

The fee calculator 130 calculates postage of the second mail group by summing the postage of the respective sub groups (S136). That is, the fee calculator 130 calculates postage of the second mail group as $39,050 by summing $3,350, the postage of the first sub group of the second mail group and $35,700, the postage of the second sub group.

The fee calculator 130 calculates combined postage by summing the postage of the first mail group and the postage of the second mail group (S137). That is, the fee calculator 130 can calculate the combined postage as $78,100 by summing $39,050, the postage of the first mail group and $39,050, the postage of the second mail group.

Referring to FIG. 2, a mileage point calculating method according to an exemplary embodiment of the present invention will now be described.

The fee calculator 130 determines the second combined fee based on acceptance information of the combined mail group (S150).

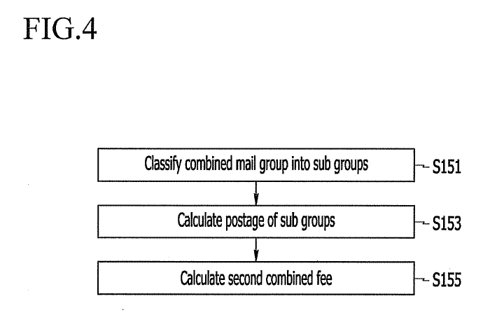

Referring to FIG. 4, a method for the fee calculator 130 to determine the second combined fee according to an exemplary embodiment of the present invention will now be described.

In this instance, according to acceptance information of the combined mail group, the grade of mail pieces included in the first mail group is first-class mail, the type is commercial letter, and the weight is less than 1 ounce. In this instance, the mail pieces included in the first mail group is configured with 200,000 mail pieces classified by a 5-digit postal code and 20,000 mail pieces classified by a 3-digit postal code.

FIG. 4 shows a second combined fee determining method according to an exemplary embodiment of the present invention.

As shown in FIG. 4, the fee calculator 130 classifies the combined mail group into at least one sub group according to the acceptance information of the combined mail group based on a stored postage table (S151). In this instance, respective sub groups include mail pieces to which the same postage is applied according to grade information, type information, weight information of, and classification information included in the combined mail group. Also, when the postage table follows Table 1, the fee calculator 130 can classify the combined mail group into a first sub group and a second sub group. In this instance, the first sub group of the combined mail group includes 200,000 mail pieces classified by a 5-digit postal code and the second sub group includes 20,000 mail pieces classified by a 3-digit postal code.

The fee calculator 130 calculates postage of respective sub groups of the combined mail group based on the postage table (S153). In this instance, when the postage table follows Table 1, the fee calculator 130 can calculate the postage of the first sub group of the combined mail group as $67,000 (=$0.335*200,000 mail pieces) and the postage of the second sub group as $7,140 (=$0.357*20,000 mail pieces).

The fee calculator 130 calculates a combined postage by summing the postage of the respective sub groups (S155). That is, the fee calculator 130 calculates the second combined fee as $74,140 by summing $67,000, the fee of the first sub group of the combined mail group and $7,140, the fee of the second sub group.

Referring to FIG. 2, a mileage point calculating method according to an exemplary embodiment of the present invention will now be described.

The mileage point computer 150 computes the margin between the first combined fee and the second combined fee as mileage points (S170). In this instance, the mileage point computer 150 computes the margin that is $3,960 between $78,100, the first combined fee and $74,140, the second combined fee as mileage points.

In order to apply the discounted fee, each classified section must include mail pieces by more than a predetermined quantity. When the amount of mail classified with the 5-digit postal code fails to reach a predetermined quantity, as expressed in Table 1, the corresponding mail is classified by the 3-digit postal code. AADC, or the mixed AADC, and when it is possible to satisfy the predetermined quantity by combining the mail pieces, the mail pieces to which the 5-digit postal code rate are increased. The difference of the fee that is reduced by mail combination can be provided as mileage points.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. In a method for a system to provide mileage points based on received data, a method for calculating mileage points comprising:
the system receiving mail acceptance data including respective acceptance information of a plurality of mail groups and acceptance information of a combined mail group generated by combining the plurality of mail groups;
the system determining a first combined fee generated by summing postage of the plurality of mail groups according to acceptance information of the plurality of mail groups;
the system determining a second combined fee corresponding to postage of the combined mail group according to acceptance information of the combined mail group; and
the system calculating a margin between the first combined fee and the second combined fee as mileage points.

2. The method of claim 1, wherein
the determining of a first combined fee includes:
the system classifying a first mail group into sub groups according to acceptance information of the first mail group from among the plurality of mail groups;
the system calculating respective postage of the sub groups according to postage information on the sub groups and quantity information of mail included in the sub groups; and
the system calculating postage of the first mail group by summing respective postage of the sub groups.

3. The method of claim 2, wherein
the first mail group includes a plurality of mail pieces, and
the classifying includes classifying the mail pieces to the sub groups according to weight information or classification information of the mail pieces.

4. The method of claim 3, wherein
the system includes postage calculation information including postage depending on weight or classification degrees, and
the calculating of respective postage of the sub groups includes the system calculating postage of the sub groups according to postage information on the sub groups and quantity information of mail included in the sub groups based on the postage calculation information.

5. The method of claim 3, wherein
the classifying includes classifying the mail pieces into a plurality of sub groups to control the sub groups to include mail pieces with an amount that is greater than a predetermined quantity.

6. The method of claim 1, wherein
the determining of a second combined fee includes:
the system classifying the combined mail group into a plurality of sub groups according to acceptance information of the combined mail group;
the system calculating respective postage of the sub groups according to postage information on the sub groups and quantity information of mail included in the respective sub groups; and
the system determining the second combined fee by summing respective postage of the sub groups.

7. A system for calculating mileage points comprising:
an information storage unit for storing a postage table;
a fee calculator for calculating postage of partial or entire mail pieces according to acceptance data of the mail pieces based on the postage table; and
a mileage point calculator for calculating mileage points on the mail pieces based on postage of partial or entire mail pieces.

8. The system of claim 7, wherein
the postage table includes postage according to weight and classification degrees of mail.

9. The system of claim 8, wherein
The acceptance data includes weight information and classification information on the mail pieces.

10. The system of claim 9, wherein
the fee calculator calculates a first combined fee by summing respective postage of a plurality of mail groups acquired by dividing the mail pieces according to the acceptance data based on the postage table, and calculates a second combined fee acquired by summing postage of the mail pieces.

11. The system of claim 10, wherein
the mileage point calculator calculates a margin between the first combined fee and the second combined fee as mileage points.
